(19) United States
(12) Patent Application Publication
(10) Pub. No.: US 2003/0129549 A1
(43) Pub. Date: Jul. 10, 2003

(54) Direct positive silver halide photographic light-sensitive material

(76) Inventors: Junji Miyata, Kanagawa (JP); Kenichi Yasuda, Kanagawa (JP); Yasufumi Morimoto, Kanagawa (JP); Kumpei Oda, Tokyo (JP); Masashi Nishiyama, Tokyo (JP)

Correspondence Address: BIRCH STEWART KOLASCH & BIRCH, PO BOX 747, FALLS CHURCH, VA, 22040-0747, US

(21) Appl. No.: 10/293,275

(22) Filed: Nov. 14, 2002

(30) Foreign Application Priority Data
Nov. 14, 2001 (JP) 2001-348504

(51) Int. Cl. G03C 1/035; G03C 1/825; G03C 1/485; G03C 1/795; G03C 1/765; G03C 7/14

(52) U.S. Cl. 430/501; 430/496; 430/510; 430/523; 430/533; 430/539; 430/596; 430/598; 430/946; 430/961

(57) ABSTRACT

A direct positive silver halide photographic light-sensitive material is used for forming a light-absorbing layer of a lenticular lens sheet that includes a film-form substrate and a plurality of light input lenses provided on a light input side of the substrate, the light absorbing layer (black stripes) being provided on a light output side of the substrate in a region other than a condensing region of each of the light input lenses, the silver halide photographic light-sensitive material including a support, and at least one light-sensitive layer having light-sensitive silver halide grains with a grain size of 1 μm or less at a silver coat weight of 1.5 g/m² or more on one side of the support, wherein on the side of the support opposite the light-sensitive layer there is no light absorbing layer, and by developing after exposing, from the side opposite the light-sensitive layer via the light input lenses, the light absorbing layer is formed based on a silver image.

### BACKGROUND OF THE INVENTION

1. Field of the Invention

The present invention relates to a direct positive silver halide photographic light-sensitive material used for producing a stripe-form light-shielding pattern, that is, a black stripe, on the surface of the light output side of a lenticular lens sheet constituting a translucent screen used in, for example, a projection television.

2. Description of the Related Art

Conventionally, back projection televisions provided with light sources formed from three, that is, red, green, and blue CRTs (Cathode Ray Tubes) and a translucent screen for projecting an image from these light sources are known, and a combination of a Fresnel lens sheet and a lenticular lens sheet is generally used therein as the translucent screen. Here, as this kind of lenticular lens sheet, those generally used are ones in which, on a light output side of a film-form substrate (hereinafter also called a ‘film substrate’) provided with a plurality of light input lenses on a light input side, black stripes are provided in regions other than condensing regions of the light input lenses, and the light is diffused over a wide range by these black stripes and at the same time the influence of external light can be reduced, thereby enhancing the contrast.

In this kind of projection television, light sources such as LCD (Liquid Crystal Display) and DMD (Digital Micro-mirror Device) are being developed as alternatives for the CRT light sources, and they are becoming widely used in areas such as data projectors, computer monitors and digital television broadcasting.

However, in projection televisions using an LCD, DMD, etc. light source, since a grid pattern due to the LCD, DMD, etc. cell structure is projected on the translucent screen, there is a possibility that a Moire pattern will be generated by the sampling effect of the lenticular lens sheet when an image is viewed by projecting it on the lenticular lens sheet, which has a repeating structure.

Because of this, in order to reduce effectively the generation of a Moire pattern in a projection television using an LCD, DMD, etc. as a light source, it is necessary to replace the conventional lenticular lens sheet, which generally uses a lens pitch of 0.5 to 1.0 mm, with a lenticular lens sheet having a small lens pitch of 0.2 mm or less.

In the above-mentioned lenticular lens sheet, as the lens pitch becomes smaller it is necessary for the pitch of the black stripes provided on the surface of the light output side of the film substrate to also become smaller.

In this type of lenticular lens sheet with a small lens pitch, as methods for forming the above-mentioned black stripes having a small pitch, in addition to a method involving printing the black stripes directly onto the surface of the light output side of the lenticular lens sheet, a photolithographic method in which a black stripe pattern is formed by exposing and developing, via light input lenses provided on the light input side of the film substrate, a resist material (resist layer) formed on the surface of the light output side of the film substrate has come to be widely used.

Under such circumstances, a method has been proposed for exposing, from the light input side of the film substrate in a lenticular lens sheet, a resist layer provided on the surface of the light output side and developing it so as to form an accurate black stripe pattern. (JP-A-12-147666 (JP-A denotes a Japanese unexamined patent application publication))

However, a resist material is used in the light absorbing layer in the above-mentioned conventional method and there are the problems that a complicated production method is necessary and that it is difficult to form a fine pitch with accuracy and high resolution.

### BRIEF SUMMARY OF THE INVENTION

The present invention is motivated by consideration of these points, and an object thereof is to provide a direct positive silver halide photographic light-sensitive material for use in easily forming accurate black stripes with high resolving power, high density, and little yellow stain.

The above-mentioned object is achieved by the following means.

A direct positive silver halide photographic light-sensitive material is used for forming a light-absorbing layer of a lenticular lens sheet comprising a film-form substrate and a plurality of light input lenses provided on a light input side of the substrate, the light absorbing layer (black stripes) being provided on a light output side of the substrate in a region other than a condensing region of each of the light input lenses, silver halide photographic light-sensitive material comprising a support, and at least one light-sensitive layer comprising light-sensitive silver halide grains with a grain size of 1 μm or less at a silver coat weight of 1.5 g/m² or more on one side of the support, wherein on the side of the support opposite the light-sensitive layer there is no light absorbing layer, and wherein by developing after exposing, from the side opposite the light-sensitive layer via the light input lenses, the light absorbing layer is formed based on a silver image.

By using the light-sensitive material of the present invention, precise black stripes having fine pitched high resolution, high density, and little yellow stain can be easily formed on the light output side of a film substrate.

### BRIEF DESCRIPTION OF THE DRAWINGS

FIGS. 1 to 4 are schematic diagrams explaining one embodiment for forming black stripes using the direct positive silver halide photographic light-sensitive material of the present invention.

FIG. 1 is a diagram showing one embodiment of a lenticular lens sheet with black stripes formed using a direct positive silver halide photographic light-sensitive material.

FIG. 2 is a diagram showing one embodiment of a film substrate and a direct positive silver halide photographic light-sensitive material before they are in intimate contact.

FIG. 3 is a diagram showing one embodiment of a film substrate and a direct positive silver halide photographic light-sensitive material after they are in intimate contact.

FIG. 4 is a diagram showing one embodiment of black stripes obtained by exposure and development of a film substrate and a direct positive silver halide photographic light-sensitive material after they are in intimate contact.

FIG. 5 is a diagram showing one embodiment of a packaging method for the direct positive silver halide photographic light-sensitive material of the present invention.

### DETAILED DESCRIPTION OF THE INVENTION

Modes for carrying out the present invention are explained below by reference to the drawings.

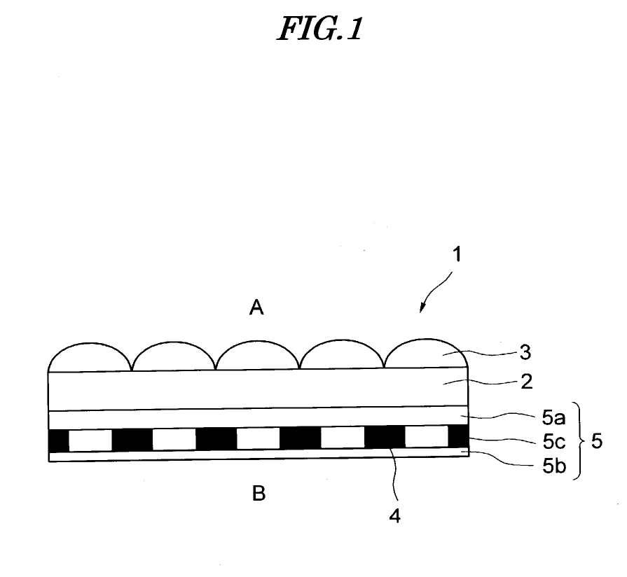

First, FIG. 1 explains a lenticular lens sheet relating to one embodiment of the present invention. As shown in FIG. 1, a lenticular lens sheet 1 has a film-form substrate (hereinafter called a ‘film substrate’) 2, a plurality of light input lenses 3 provided on the light input side A of the film substrate 2, and black stripes (light absorbing layer) 4 provided on the light output side B of the film substrate 2 in regions other than condensing regions of the light input lenses 3. In the figure, 5 is a direct positive silver halide photographic light-sensitive material after exposure and development, 5a is a support, 5b is a protective layer, and 5c is a light-sensitive layer. These black stripes 4 can be formed by development after exposing, from the light input side of the film substrate 2 via the light input lenses 3, the direct positive silver halide photographic light-sensitive material in intimate contact with the surface of light output side of the film substrate 2.

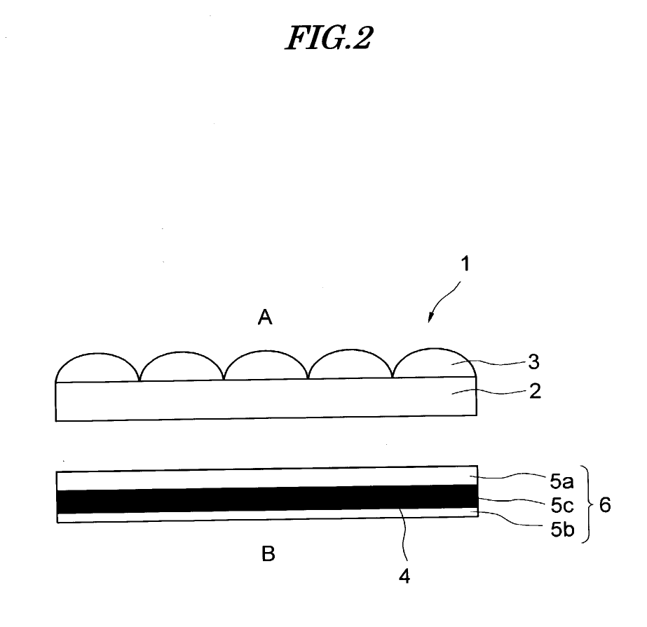

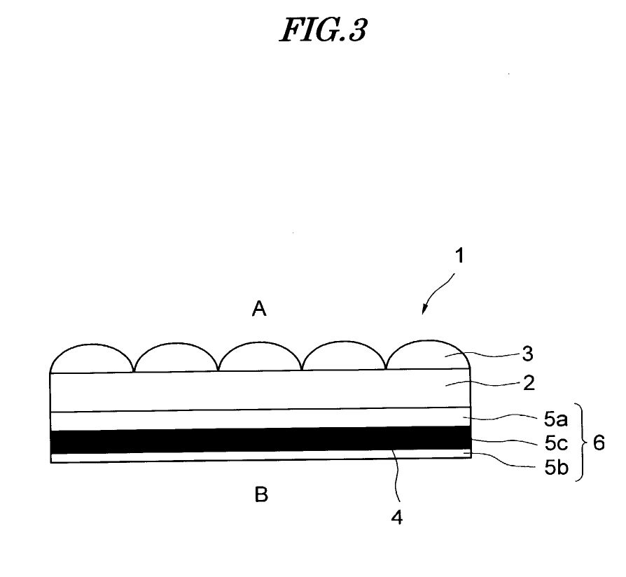

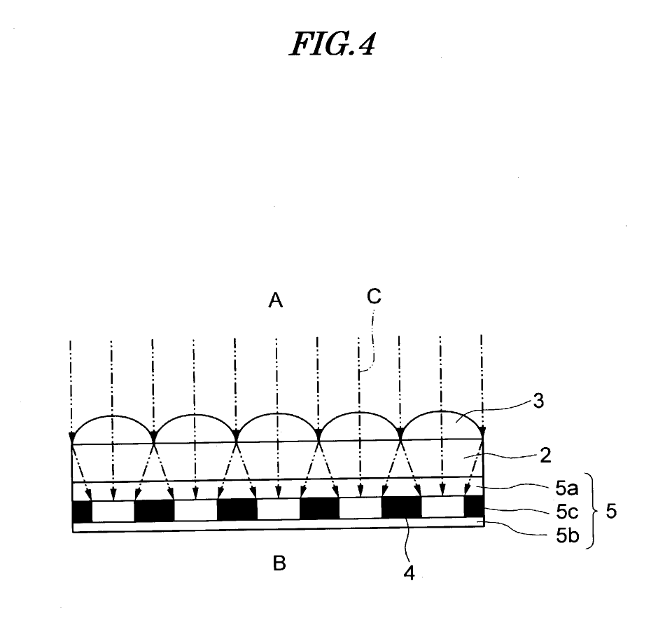

That is, as shown in FIG. 2 and FIG. 3, the side opposite the light-sensitive layer 5c of the support 5a of the direct positive silver halide photographic light-sensitive material 5 is first brought into intimate contact with the film substrate 2. The direct positive silver halide photographic light-sensitive material 5 of the present invention has no light absorbing layer on the side of the support 5a opposite the light-sensitive layer 5c. Therefore, as shown in FIG. 4, by subsequently exposing the photographic light-sensitive material 6 through the light input lenses 3 and processing in that state, the black stripes 4 can be formed. In the figure, C denotes light exposure beams.

In a conventional negative resist method, a resist layer is exposed and developed, the negative resist material is left behind in condensing regions of the light input lenses as a negative resist layer, it is necessary to fill regions, other than the condensing regions, from which the negative resist material has been removed, with a coloring ink such as a black ink, and the manufacture thereof is therefore complicated. By using the direct positive silver halide photographic light-sensitive material, fine pitched high resolution black stripes can be easily formed.

Furthermore, after exposure and processing, the surface of the light output side of the direct positive silver halide photographic light-sensitive material can be covered with a high transmittance translucent clear layer.

The clear layer can be formed on the direct positive silver halide photographic light-sensitive material after exposure and development by lamination or coating. Moreover, a light diffusing layer can be provided.

Furthermore, a surface treatment layer, etc. such as an anti-reflection layer, a low reflection layer, an anti-scratch layer (hardcoat layer), an antistatic layer, an anti-glare layer, an anti-contamination layer, a polarizing filter layer, an electromagnetic shield layer, and a touch-sensitive layer may be provided on the surface of the light output side (viewing side surface).

In the direct positive silver halide photographic light-sensitive material of the present invention, in order to form black stripes that accurately match the pattern of exposure by exposing and then processing, together with the film substrate, the light-sensitive material, which has the light-sensitive layer containing a light-sensitive silver halide on the support, it is necessary for the side opposite the light-sensitive layer to have no light absorbing layer. Furthermore, in order to protect the surface of the light-sensitive layer and prevent scratches, it is preferable for the exterior of the image-forming layer to have a protective layer. A hydrophilic colloid is used as a binder in these protective layers, and gelatin is more preferably used. The thickness of the protective layer is preferably at least 0.5 μm.

Furthermore, a light insensitive layer can be provided between the light-sensitive layer and the support in the photographic light-sensitive material of the present invention. A dye, etc. can also be added to this light insensitive layer so as to form an anti-halation layer.

Moreover, the light-sensitive layer can be divided into two or more layers as necessary. Other than the above-mentioned light-sensitive layer, protective layer, and light insensitive layer, various auxiliary layers such as an undercoat layer and an intermediate layer can be provided in the photographic light-sensitive material.

In the direct positive silver halide photographic light-sensitive material used in the present invention, in order for stray light at the surface in intimate contact with the film substrate to have little influence, it is preferable for the distance from the surface in intimate contact to the light-sensitive layer to be short. Specifically, the total thickness of the photographic light-sensitive material is preferably at least 25 μm and at most 200 μm.

The emulsion used in the direct positive silver halide light-sensitive material used in the present invention is formed from silver halide grains having within the silver halide a nucleus that can trap a free electron, and having a pre-fogged surface. As this type of free electron trapping nucleus in the emulsion, at least one type of salt of rhodium, ruthenium, osmium, rhenium, or iridium can be used. For example, emulsions described in JP-B-43-4125 (JP-B denotes Japanese examined patent application publication), JP-B-43-29405, U.S. Pat. Nos. 2,401,051, 2,976,149, and 3,023,102 British Patent Nos. 707704, and 1097999, French Patent Nos. 1520824, and 1520817, and Belgian Patent Nos. 713272, 721567, and 681768 can be used.

The silver halide grains used in the present invention can be of any composition. That is, any of silver chloride, silver bromide, silver chlorobromide, silver iodochlorobromide, and silver iodobromide can be used, but silver bromide, silver chlorobromide, or silver chloride is preferably used. In cases of silver chlorobromide, the silver chloride content is preferably 0 to 10 mol % or 80 to 100 mol %, and in a case where silver iodochlorobromide is used the silver chloride content is preferably 0 to 80% and the silver iodide content is preferably 0 to 10%. In compositions other than these the developed silver has a yellowish tinge, which is undesirable. The grain size is 0.05 to 1.0 μm, and preferably 0.10 to 0.40 μm. The silver halide grains in the photographic emulsion preferably have a regular crystal form such as cubic or octahedral. Furthermore, a narrow grain size distribution is preferred, and in particular one in which 90%, and desirably 95% of the total number of grains is within the range of ±40% of the average grain size, a so-called monodisperse emulsion, is preferred. The amount of the silver halide emulsion coated is preferably at least 1.5 g/m² and at most 10 g/m², and more preferably at least 2.0 g/m² and at most 5.0 g/m².

The internal electron trapping nucleus used in the direct positive silver halide emulsion of the present invention can be incorporated by adding a salt compound of rhodium, ruthenium, osmium, rhenium, or iridium to the silver halide grains so as to be present in an amount of 10⁻⁷ to 10⁻³ mol, and preferably 10⁻⁶ to 10⁻⁴ mol, per mol of the silver halide.

As preferred transition metal complexes used in the present invention for incorporating the above-mentioned electron trapping nuclei, hexacoordinate metal complexes represented by the formula below are preferred.

[M(NY)ₙL₍₆₋ₙ₎]^{m}

(In the formula, M is rhodium, ruthenium, osmium, rhenium, or iridium, and L is a bridging ligand. Y represents oxygen or sulfur. m=0, 1−, 2−, or 3−, and n=0, 1, or 2)

As preferred specific examples of L other than nitrosyl and thionitrosyl bridging ligands, there can be cited halide ligands (fluoride, chloride, bromide, and iodide), cyanide ligand, cyanate ligand, thiocyanate ligand, selenocyanate ligand, tellurocyanate ligand, azido ligand, and aquo ligand. When an aquo ligand is present, it preferably occupies one or two of the ligands. The above-mentioned metal complexes can be incorporated into the silver halide by adding them during preparation of the silver halide grains. The timing of addition can be such that they are uniformly distributed in the whole silver halide grain, but it is preferred that the addition is such that they are present in an inner shell section of the silver halide grain.

A known method may be used for fogging the direct positive silver halide emulsion of the present invention, and it can be achieved by a light or a chemical treatment. Such fogging has been achieved by many methods such as carrying out chemical sensitization until fog is generated and, for example particularly preferred results are obtained by a method described in ‘Science et Industrie, Photographique 28, January 1957, pages 57 to 65. Silver halide grains can be fogged by intense light, by reduction fogging with thiourea dioxide or stannous chloride, or by gold or precious metal compounds. A combination of a reducing agent with a gold compound or a compound of a metal more electropositive than silver such as rhodium, platinum or iridium can also be used for silver halide grain fogging. From the point of view of high sensitivity and reduction in Dₘᵢₙ, the direct positive photographic emulsion of the present invention is preferably one formed from silver halide grains fogged by carrying out reduction fogging and gold fogging on silver halide grains, that is, fogging with both a reduction fogging agent and a gold fogging agent. In such a combination, when the reduction fogging agent and the gold fogging agent are each used at a low concentration, fogged silver halide grains can be obtained with the unique characteristic of the fogging being rapidly faded by chemical bleaching. It is known that one equivalent of reducing agent reduces one equivalent of silver halide to silver. In order to obtain fogged silver halide grains with the characteristic of the fogging rapidly fading by bleaching, far less than one equivalent of the reduction fogging agent is used. That is, it is used in the range of 1.0×10⁻⁶ to 1.0×10⁻¹ mol per mol of silver halide to fog the silver halide grains. When there is a high concentration of reducing agent, it brings about a great loss in photographic speed.

As examples of the reduction fogging agent used for producing the direct positive emulsion of the present invention, there are hydrazines, phosphonium salts exemplified by tetra(hydroxymethyl) phosphonium chloride, and thiourea dioxide (these are described in U.S. Pat. Nos. 3,062,651 and 2,983,609); stannous salts such as stannous chloride (ref. U.S. Pat. No. 2,487,850); polyamines exemplified by diethylenetriamine (ref. U.S. Pat. No. 2,519,698); polyamines exemplified by spermine (ref. U.S. Pat. No. 2,521,925); and bis(β-aminoethyl)sulfide and water soluble salts thereof (ref. U.S. Pat. 2,521,926), etc.

The gold fogging agent used for producing the direct positive emulsion of the present invention is any gold salt that can be used to fog photographic silver halide grains, for example those described in the specification of U.S. Pat. Nos. 2,399,083 and 2,642,361, and examples thereof include potassium chloroaurite, potassium aurithiocyanate, potassium chloroaurate, auric trichloride, and aurosulfobenzothiazole methochloride. The concentration of the gold fogging agent used for producing the direct positive emulsion of the present invention can be varied over a wide range, but it is generally in the range of 1.0×10⁻⁸ to 1.0×10⁻⁴ mol per mol of the silver halide. Potassium chloroaurate is a particularly preferred gold fogging agent, and is used at a concentration of about 5 mg or less per mol of the silver halide, and preferably at a concentration of about 0.5 to 4 mg per mol of the silver halide. In the case where the gold fogging agent is used in combination with a reduction fogging agent, it is preferable for the major portion of the fogging agent combination to be the gold fogging agent, and the ratio of the gold fogging agent to the reduction fogging agent is generally about 1:3 to about 20:1, but there are frequently cases where it is about 2:1 to 20:1. It is preferable to first fog the silver halide grains using the reduction fogging agent and then to fog with the gold fogging agent. However, the reverse is also possible, and it is also possible to use the reduction fogging agent and the gold fogging agent simultaneously. When carrying out the present invention, the silver halide grains can be fogged before coating, or they can be fogged after coating. The reaction conditions when fogging the silver halide grains can be varied over a wide range, but generally the pH is about 5 to 7, the pAg is about 7 to 9, and the temperature is about 40 to 100° C., and most commonly in the range of about 50 to 70° C.

In the direct positive silver halide photographic light-sensitive material of the present invention it is preferable to use a water soluble dye or a solid dispersible dye having its main absorption in the visible wavelength region within the intrinsic light-sensitive wavelength region of the silver halide emulsion used. A dye having a λₘₐₓ in the range 350 nm to 600 nm is particularly preferred. The chemical structure of the dye added is not particularly limited, and oxonol dyes, hemioxonol dyes, merocyanine dyes, cyanine dyes, azo dyes, etc. can be used. Specifically, as the water soluble dyes, for example, pyrazolone dyes described in JP-B-58-12576, pyrazolone oxonol dyes described in U.S. Pat. No. 2,274,782, diaryl azo dyes described in U.S. Pat. No. 2,956,879, styryl dyes and butadienyl dyes described in U.S. Pat. Nos. 3,423,207 and 3,384,487, merocyanine dyes described in U.S. Pat. No. 2,527,583, merocyanine dyes and oxonol dyes described in U.S. Pat. Nos. 3,486,897, 3,652,284, and 3,718,472, enamino hemioxonol dyes described in U.S. Pat. No. 3,976,661, and dyes described in British Patent Nos. 584,609, and 1,177,429, JP-A-48-85130, JP-A-49-99620, JP-A-49-114420, and U.S. Pat. Nos. 2,533,472, 3,148,187, 3,177,078, 3,247,127, 3,540,887, 3,575,704, and 3,653,905 can be used.

With regard to the dye that can be dispersed as a solid in microcrystalline form, with the object of improving both tone reproduction and tone variability it is preferable that it is added to the light insensitive layer provided between the emulsion layer and the support. The amount of this dye coated is preferably 10 mg to 500 mg per m², and particularly preferably 50 mg to 300 mg. The dyes used in the present invention can be synthesized easily by the methods, or based on the methods, described in WO88/04794, EP-0274723-A1, EP-276,566, EP-299,435, JP-A-52-92716, JP-A-55-155350, JP-A-55-155351, JP-A-61-205934, JP-A-48-68623, U.S. Pat. Nos. 2,527,583, 3,486,897, 3,746,539, 3,933,798, 4,130,429, 4,040,841, Japanese Patent Application Nos. 1-50874, 1-103751, and 1-307363, etc.

Furthermore, in order to improve safelight safety, etc., the solid dispersed dye and/or the water soluble dye can be added, in a range that does not impair the effect of the present invention, to layers other than that above in the direct positive silver halide photographic light-sensitive material of the present invention. When added to the emulsion layer, the amount added is preferably in a range such that the resulting reduction in sensitivity does not exceed 0.2 expressed as logE, and is, for example, 5 to 100 mg/m².

Various other generally used photographic additives can be included in the direct positive silver halide photographic light-sensitive material of the present invention.

As stabilizers, for example, triazoles, azaindenes, quaternary benzothiazolium compounds, mercapto compounds, or water soluble inorganic salts of cadmium, cobalt, nickel, manganese, gold, thallium, zinc, etc. can be included.

Furthermore, as hardening agents, for example, aldehydes such as formalin, glyoxal, and mucochloric acid, s-triazines, epoxides, aziridines, vinylsulfonic acid, etc., or as coating adjuvants, for example, saponin, sodium polyalkylene sulfonates, lauryl and oleyl monoethers of polyethylene glycol, acylated alkyl taurines, fluorinated compounds, etc, can be included.

Moreover, a color coupler can also be included. In addition, whitening agents, UV absorbers, preservatives, matting agents, antistatic agents, etc. can be included as necessary.

Various surfactants can be included in the photographic emulsion layer or another hydrophilic colloid layer of the direct positive silver halide photographic light-sensitive material of the present invention for a various purposes, such as aiding coating, preventing static, improving slip, emulsification dispersion, preventing adhesion, and improving photographic properties (for example, accelerating development, enhancing high contrast, and sensitization). For example, it is possible to use nonionic surfactants such as saponin (steroid-based), alkylene oxides (for example, polyethylene glycol, polyethylene glycol/polypropylene glycol condensates, polyethylene glycol alkyl ethers or polyethylene glycol alkyl aryl ethers, polyethylene glycol esters, polyethylene glycol sorbitan esters, polyalkylene glycol alkyl amines or amides, and polyethylene oxide adducts of silicones), glycidol derivatives (for example, alkenyl succinate polyglycerides and alkyl phenol polyglycerides), fatty acid esters of polyhydric alcohols, and sugar alkyl esters; anionic surfactants containing an acid group such as a carboxy group, sulfo group, phospho group, sulfate ester group, or phosphate ester group, such as alkyl carboxylates, alkyl sulfonates, alkylbenzenesulfonates, alkylnaphthalenesulfonates, alkyl sulfate esters, alkyl phosphate esters, N-acyl-N-alkyltaurines, sulfosuccinate esters, sulfoalkylpolyoxyethylene alkyl phenyl ethers, and polyoxyethylene alkyl phosphate esters; amphoteric surfactants such as amino acids, aminoalkylsulfonic acids, aminoalkyl sulfate or phosphate esters, alkyl betaines, and amine oxides; and cationic surfactants such as alkylamine salts, aliphatic or aromatic quaternary ammonium salts, heterocyclic quaternary ammonium salts such as pyridinium and imidazolium, and aliphatic- or heterocyclic-containing phosphonium salts or sulfonium salts. Polyalkylene oxides having a molecular weight of at least 600 described in JP-B-58-9412 are particularly preferably used as surfactants in the present invention.

The polyalkylene oxide compounds used in the present invention include alkylene oxides having 2 to 4 carbons, for example, ethylene oxide, propylene-1,2-oxide, butylene-1,2-oxide, etc., and preferably a condensate of a polyalkylene oxide formed from at least 10 units of ethylene oxide with a compound having at least one active hydrogen atom, such as water, an aliphatic alcohol, an aromatic alcohol, a fatty acid, an organic amine, and a hexitol derivative, or a block copolymer of at least two types of polyalkylene oxides. That is, as the polyalkylene oxide compounds that can be used there are specifically

polyalkylene glycols

polyalkylene glycol alkyl ethers

polyalkylene glycol aryl ethers

polyalkylene glycol (alkyl aryl) ethers

polyalkylene glycol esters

polyalkylene glycol fatty acid amides

polyalkylene glycol amines

polyalkylene glycol block copolymers

polyalkylene glycol graft polymers, etc. It is necessary for the molecular weight to be at least 600. The polyalkylene oxides are not limited to one in the molecule, and two or more may be included. In that case, the individual polyalkylene oxides can be formed from less than 10 alkylene oxide units, but there must be a total of at least 10 alkylene oxide units in the molecule. When there are 2 or more polyalkylene oxides in the molecule, they can each be formed from different alkylene oxide units, for example, ethylene oxide and propylene oxide. The polyalkylene oxide compounds used in the present invention are preferably those containing at least 14 and at most 100 alkylene oxide units. Specific examples of the polyalkylene oxide compounds used in the present invention are as follows.

HO(CH₂CH₂O)₉₀H

C₄H₉O(CH₂CH₂O)₁₅H

C₁₂H₂₅O(CH₂CH₂O)₁₅H

C₁₈H₃₇O(CH₂CH₂O)₁₅H

C₁₈H₃₇O(CH₂CH₂O)₄₀H

C₈H₁₇CH═CHC₈H₁₆O(CH₂CH₂O)₁₅H

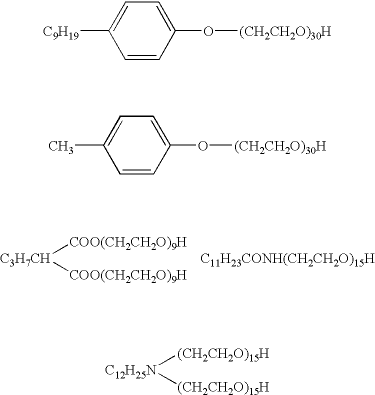

CH₁₄H₂₉N(CH₂)(CH₂CH₂O)₂₄H

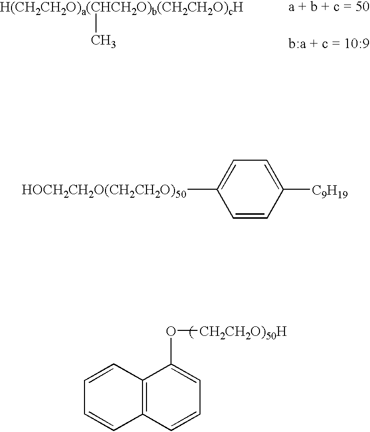

When these polyalkylene oxide compounds are added to the silver halide emulsion, they are dissolved at a suitable concentration in an aqueous solution, or in a low boiling point organic solvent that is miscible with water, and can be added to the emulsion at a suitable time before coating, and preferably after chemical ripening. Instead of adding them to the emulsion, they can be added to a light insensitive hydrophilic colloid layer, for example an intermediate layer, a protective layer, a filter layer, etc.

A matting agent such as silica, magnesium oxide, or polymethyl methacrylate can be included in the photographic emulsion layer and another hydrophilic colloid layer of the photographic light-sensitive material of the present invention for the purpose of preventing adhesion. A water insoluble or hardly soluble synthetic polymer dispersion can be included in the photographic emulsion of the present invention with the object of improving the dimensional stability, etc. For example, alkyl (meth)acrylates, alkoxyalkyl (meth)acrylates, (meth)acrylamides, vinyl esters (for example vinyl acetate), acrylonitrile, etc., can be used singly or in combination.

Gelatin is mainly used as a protective colloid in the emulsion used in the present invention, and it is particularly advantageous to use inert gelatin. Instead of gelatin, a photographically inert gelatin derivative (for example, phthalated gelatin, etc.) a water soluble synthetic polymer, for example, polyvinyl acrylate, polyvinyl alcohol, polyvinyl pyrrolidone, etc. can be used. The silver halide emulsion of the present invention can use any suitable photographic support, for example, glass, or a film base such as cellulose acetate, cellulose acetate butyrate, or a polyester (for example poly(ethylene terephthalate)).

A developing solution used for processing the light-sensitive material of the present invention is now explained. As hydroquinone-based developing agents used in the present invention, there are hydroquinone, chlorohydroquinone, bromohydroquinone, isopropyl hydroquinone, methyl hydroquinone, 2,3-dibromohydroquinone, 2,5-dimethyl hydroquinone, etc., but hydroquinone is particularly preferred. The concentration of the hydroquinone derivative in the developing solution is 0.2 to 0.75 mol/L, preferably 0.2 to 0.5 mol/L, and particularly preferably 0.2 to 0.4 mol/L.

As 1-phenyl-3-pyrazolidone derivative developing agents used in the present invention, there are 1-phenyl-3-pyrazolidone, 1-phenyl-4,4-dimethyl-3-pyrazolidone, 1-phenyl-4-methyl-4-hydroxymethyl-3-pyrazolidone, 1-phenyl-4,4-dihydroxymethyl-3-pyrazolidone, 1-phenyl-5-methyl-3-pyrazolidone, 1-p-aminophenyl-4,4-dimethyl-3-pyrazolidone, 1-p-tolyl-4,4-dimethyl-3-pyrazolidone, 1-p-tolyl-4-methyl-4-hydroxymethyl-3-pyrazolidone, etc. The concentration of the 1-phenyl-3-pyrazolidone derivative is 0.001 to 0.06 mol/L, preferably 0.001 to 0.02 mol/L, and particularly preferably 0.003 to 0.01 mol/L.

Furthermore, a compound shown in formula (I) below and/or formula (II) below is preferably included.

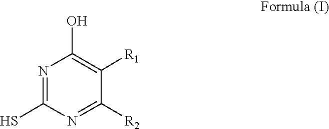

In the formula, R₁ and R₂ independently represent a hydrogen atom, an alkyl group, an aryl group, an aralkyl group, a hydroxy group, a mercapto group, a carboxy group, a sulfo group, a phosphono group, an amino group, a nitro group, a cyano group, a halogen atom, an alkoxycarbonyl group, an aryloxycarbonyl group, a carbamoyl group, a sulfamoyl group, or an alkoxy group. Furthermore, R₁ and R₂ can be connected to form a ring structure.

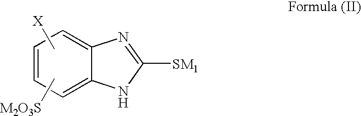

In the formula, X represents a hydrogen atom or a sulfonic acid group. M₁ represents a hydrogen atom or an alkali metal atom. M₂ represents a hydrogen atom, an alkali metal atom, or an ammonium group.

Formula (I) is now explained in detail. As preferred examples of R₁ and R₂, either one of R₁ and R₂ can be an alkyl group of 1 to 10 carbons, which may be substituted, an aryl group of 6 to 12 carbons, which may be substituted, an aralkyl group of 7 to 12 carbons, which may be substituted, a nitro group, a cyano group, and a halogen atom. The sum of the carbons of R₁ and R₂ is preferably 2 to 20. A case where R₁ and R₂ are connected to form a saturated 5- to 6-membered ring can be cited as a preferred example.

Of R₁ and R₂, as more preferred examples of R₁ there can be cited a hydrogen atom, or an alkyl group having as a substituent an amino group or a heterocyclic group, and as more preferred examples of R₂ there can be cited an alkyl group of 1 to 10 carbons, which may be substituted, an aryl group of 6 to 12 carbons, which may be substituted, and R₁ and R₂ connected to form a saturated 5- to 6-membered ring. As specific examples thereof, there can be cited, as R₁, a dimethylaminomethyl group, a morpholinomethyl group, an N-methylpiperazinylmethyl group, a pyrrolidinylmethyl group, etc. As R₂, there can be cited a methyl group, an ethyl group, a phenyl group, a p-methoxyphenyl group, etc.

As specific examples of the compounds denoted by formula (I), there can be cited I-1 to I-14 in JP-A-5-232641, but the compounds are not limited thereto.

The preferred amount added of the compound of formula (I) is 0.01 to 100 mmol per liter of the developing solution, and more preferably 0.1 to 10 mmol per liter.

When M₁ is hydrogen in the compound represented by formula (II) of the present invention, the compound can also be a tautomer thereof. Each of the lower alkyl group and lower alkoxy group represented by X in the above-mentioned formula (II) means a group having 1 to 5 carbon atoms, but it is preferably a group having 1 to 3 carbon atoms. As preferred compounds represented by formula (II) there can be cited those below, but the compounds are not limited thereto.

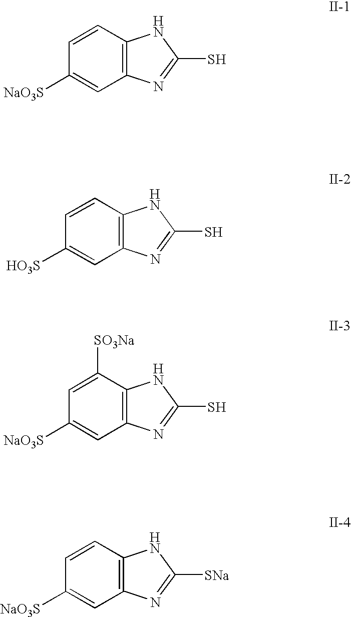

The preferred amount added of the compound of formula (II) is 0.01 to 100 mmol per liter of the developing solution, and more preferably 0.1 to 10 mmol per liter.

Furthermore, it is preferable to use a developing solution in which is included a compound denoted by formula (III) below in a concentration ratio (compound denoted by formula (III) below/hydroquinone-based developing agent) in the range of 0.03 to 0.12, and at a pH of 9.5 to 12.

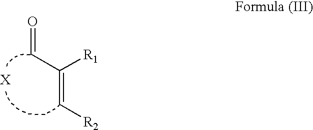

In the formula, R₁ and R₂ each represent a hydroxy group, an amino group, an acylamino group, an alkylsulfonylamino group, an arylsulfonylamino group, an alkoxycarbonylamino group, a mercapto group, or an alkyl thio group, X is formed from carbon, oxygen or nitrogen atoms and, together with the two vinyl carbons substituted with R₁ and R₂ and the carbonyl carbon, forms a 5- to 6-membered ring

Formula (III) is explained in more detail below. In the formula, each of R₁ and R₂ represents a hydroxy group, an amino group (including those having as a substituent an alkyl group of 1 to 10 carbons, for example, a methyl group, an ethyl group, an n-butyl group, a hydroxyethyl group, etc.), an acylamino group (an acetylamino group, a benzoylamino group, etc.), an alkylsulfonylamino group (a methanesulfonylamino group, etc.), an arylsulfonylamino group (a benzenesulfonylamino group, a p-toluenesulfonylamino group, etc.), an alkoxycarbonylamino group (a methoxycarbonylamino group, etc.), a mercapto group, or an alkylthio group (a methylthio group, an ethyl thio group, etc.).

As preferred examples of R₁ and R₂, there can be cited a hydroxy group, an amino group, an alkylsulfonylamino group, and an arylsulfonylamino group. X is formed from carbon, oxygen, or nitrogen atoms and, together with the two vinyl carbons substituted with R₁ and R₂ and the carbonyl carbon, forms a 5- to 6-membered ring.

As specific examples of X, it is formed from a combination of —O—, —C(R₃)(R₄)-, —C(R₅)═, —C(═O)—, —N(R₆)-, and —N═. R₃, R₄, R₅, and R₆ represent a hydrogen atom, an alkyl group of 1 to 10 carbons, which may be substituted (as substituents there can be cited a hydroxy group, a carboxy group, and a sulfo group), an aryl group of 6 to 15 carbons, which may be substituted (as substituents there can be cited an alkyl group, a halogen atom, a hydroxy group, a carboxy group, and a sulfo group), a hydroxy group, or a carboxy group.

Moreover, a saturated or unsaturated condensed ring can be formed on this 5- to 6-membered ring. As examples of this 5- to 6-membered ring there can be cited a dihydrofuranone ring, a dihydropyrone ring, a pyranone ring, a cyclopentenone ring, a cyclohexenone ring, a pyrrolinone ring, a pyrazolinone ring, a pyridone ring, an azacyclohexenone ring, a uracil ring, etc., and as examples of preferred 5- to 6-membered rings there can be cited a dihydrofuranone ring, a cyclopentenone ring, a cyclohexenone ring, a pyrazolinone ring, an azacyclohexenone ring, and a uracil ring.

As specific examples of the compounds of formula (III) there can be cited the compounds described as A-1 to A-22 in Japanese Patent Application No. 4-288747. Among these, ascorbic acid or erythorbic acid (optical isomers) (A-1) is preferred.

The preservative used in the processing developing solution of the present invention is free sulfite ion, and it is added to the developing solution in the form of sodium sulfite, lithium sulfite, ammonium sulfite, sodium bisulfite, etc. The concentration of free sulfite ion is 0.3 to 1.2 mol/L, preferably 0.4 to 1.0 mol/L, and particularly preferably 0.5 to 0.8 mol/L.

The pH of the developing solution used in the processing of the present invention is in the range from 9.5 to 12.0, and preferably 9.7 to 11.0. An alkali agent used for setting the pH includes a pH adjusting agent such as sodium hydroxide, sodium carbonate, trisodium phosphate, potassium hydroxide, or potassium carbonate. A boric acid salt, which is usually used as a buffer agent, forms a complex with an ascorbic acid derivative compound, and is preferably not present in the developing solution.

Furthermore, a dialdehyde hardening agent or a bisulfite adduct thereof is used in the developing solution used in the processing of the light-sensitive material of the present invention. Specific examples thereof include glutaraldehyde, α-methylglutaraldehyde, β-methylglutaraldehyde, maleic dialdehyde, succindialdehyde, methoxysuccindialdehyde, methylsuccindialdehyde, α-methoxy-β-ethoxyglutaraldehyde, α-n-butoxyglutaraldehyde, α,α-diethylsuccindialdehyde, butylmaleic dialdehyde, or bisulfite adducts thereof. Among these, glutaraldehyde or its bisulfite adduct is most commonly used. The dialdehyde compounds can be used in an amount such that the sensitivity of the processed photographic layer is not inhibited and the drying time is not noticeably lengthened. Specifically, the amount is 1 to 50 g, and preferably 3 to 10 g, per liter of the developing solution.

An antifoggant is used in the developing solution used in processing the light-sensitive material of the present invention and, for example, there are indazoles, benzimidazoles, or benztriazoles. Examples thereof include 5-nitroindazole, 5-p-nitrobenzoylaminoindazole, 1-methyl-5-nitroindazole, 6-nitroindazole, 3-methyl-5-nitroindazole, 5-nitrobenzimidazole, 2-isopropyl-5-nitrobenzimidazole, 5-nitrobenztriazole, sodium 4-[(2-mercapto-1,3,4,-thiadiazol-2-yl)thio]butanesulfonate, and 5-amino-1,3,4-thiadiazol-2-thiol.

The amount of these antifoggants is usually 0.01 to 10 mmol, and more preferably 0.1 to 2 mmol per liter of the developing solution. Other than these organic antifoggants, for example, halides such as potassium bromide and sodium bromide can be used.

Moreover, various kinds of organic/inorganic chelating agents can be added to the developing solution used in processing the light-sensitive material of the present invention. As the inorganic chelating agents, sodium tetrapolyphosphate, sodium hexametaphosphate, etc. can be used. As the organic chelating agents, primarily organic carboxylic acids, aminopolycarboxylic acids, organic phosphonic acids, aminophosphonic acids, and organic phosphonocarboxylic acids can be used. As the organic carboxylic acids, acrylic acid, oxalic acid, malonic acid, succinic acid, glutaric acid, adipic acid, pimelic acid, suberic acid, azelaic acid, sebacic acid, nonanedicarboxylic acid, decanedicarboxylic acid, undecanedicarboxylic acid, maleic acid, itaconic acid, malic acid, citric acid, tartaric acid, etc. can be cited, but the present invention is not limited thereto.

As the aminopolycarboxylic acid there can be cited iminodiacetic acid, nitrilotriacetic acid, nitrilotripropionic acid, ethylenediaminemonohydroxyethyltriacetic acid, ethylenediaminetetraacetic acid, glycol ether tetraacetic acid, 1,2-diaminopropanetetraacetic acid, diethylenetriaminepentaacetic acid, triethylenetetraminehexaacetic acid, 1,3-diamino-2-propanoltetraacetic acid, glycol ether diaminetetraacetic acid, and compounds described in JP-A-52-25632, JP-A-55-67747, JP-A-57-102624, and JP-B-53-40900.

As the organic phosphonic acids there can be cited hydroxyalkylidene diphosphonic acids described in U.S. Pat. Nos. 3,214,454 and 3,794,591 and West German Unexamined Patent Publication No. 2227639, and compounds described in Research Disclosure, Vol. 181, Item 18170 (May, 1979). As the aminophosphonic acids there can be cited aminotris(methylenephosphonic acid), ethylenediaminetetramethylenephosphonic acid, aminotrimethylenephosphonic acid, etc., and compounds described in the above-mentioned Research Disclosure No. 18170, JP-A-57-208554, JP-A-54-61125, JP-A-55-29883, JP-A-56-97347, etc.

As the organic phosphonocarboxylic acids there can be cited compounds described in JP-A-52-102726, JP-A-53-42730, JP-A-54-121127, JP-A-55-4024, JP-A-55-4025, JP-A-55-126241, JP-A-55-65955, JP-A-55-65956, the above-mentioned Research Disclosure No. 18170, etc. These chelating agents may be used in the form of alkali metal salts or ammonium salts. The amount of these chelating agents added is preferably 1×10⁻⁴ to 1×10⁻¹ mol, and more preferably 1×10⁻³ to 1×10⁻² mol per liter of the developing solution.

The developing solution used in processing the light-sensitive material of the present invention can contain as necessary, in addition to the above-mentioned composition, a buffer (for example, a carbonate or an alkanolamine), an alkali agent (for example, a hydroxide or a carbonate), a dissolution aid (for example, polyethylene glycols and esters thereof), a pH adjusting agent (for example, an organic acid such as acetic acid), a development accelerator (for example, various pyridinium compounds and other cationic compounds described in U.S. Pat. No. 2,648,604, JP-B-44-9503, and U.S. Pat. No. 3,171,247; cationic dyes such as phenosafranine; neutral salts such as thallium nitrate and potassium nitrate; polyethylene glycol and derivatives thereof described in JP-B-44-9304, and U.S. Pat. Nos. 2,533,990, 2,531,832, 2,950,970 and 2,577,127; nonionic compounds such as polythioethers; organic solvents described in JP-B-44-9509 and Belgian Patent 682,862; thioether based compounds described in U.S. Pat. No. 3,201,242, etc., the thioether-based compounds being particularly preferred); a surfactant, etc.

The processing temperature and time are interrelated and are determined in relation to the total processing time, but generally the processing temperature is from about 20° C. to about 50° C., and the processing time is from 10 seconds to 2 minutes. When 1 m² of the photographic light-sensitive material of the present invention is processed, the volume of replenisher for the developing solution is 300 ml or less, and preferably 170 ml or less.

Following after the development process, a fixing process is carried out. The fixing solution for use in the fixing process is an aqueous solution containing sodium thiosulfate, ammonium thiosulfate and, as necessary, tartaric acid, citric acid, gluconic acid, boric acid, and salts thereof. The pH is usually from about 3.8 to about 7.0, but is preferably from 5.0 to 7.0, and particularly preferably from 5.2 to 6.0.

Of the above components, the main fixing agent is sodium thiosulfate or ammonium thiosulfate. The amount of thiosulfate used is from 0.5 to 2.0 mol/L, preferably from 0.7 to 1.6 mol/L, and particularly preferably from 1.0 to 1.5 mol/L.

The fixing solution can include, as desired, a hardening agent (for example, a water-soluble aluminum compound), a preservative (for example, a sulfite or bisulfite), a pH buffer agent (for example, acetic acid or boric acid), a pH adjusting agent (for example, ammonia or sulfuric acid), a chelating agent, a surfactant, a wetting agent, and a fixing accelerator.

As the surfactant there can be cited, for example, anionic surfactants such as sulfates and sulfonates, polyethylene surfactants, and amphoteric surfactants described in JP-A-57-6840. Known antifoaming agents can also be used. As the wetting agent, for example, there can be cited alkanolamines and alkyl glycols. As the fixing accelerator there can be cited, for example, thiourea derivatives described in JP-B-45-35754, JP-B-58-122535 and JP-B-58-122536, alcohols having a triple bond in the molecule, thioether compounds described in U.S. Pat. No. 4,126,459, and mesoionic compounds described in JP-A-4-229860. As the pH buffer agent, for example, organic acids such as acetic acid, malic acid, succinic acid, tartaric acid, and citric acid, and inorganic buffer agents such as boric acid, phosphates, and sulfites can be used. Inorganic buffer agents are preferably used from the viewpoint of the control of odor and rust generation on the equipment. The pH buffer agent is used with the object of preventing the pH of the fixing solution rising due to developing solution carryover, and is used in an amount of 0.1 to 1.0 mol/L, and more preferably about 0.2 to 0.6 mol/L.

As a stabilizing agent for the water soluble aluminum salt of the fixing solution in the present invention, gluconic acid, iminodiacetic acid, glucoheptanoic acid, 5-sulfosalicylic acid, derivatives thereof, and salts thereof are preferred. The gluconic acid may be dehydrated to form a lactone ring. Among these compounds, gluconic acid, iminodiacetic acid, alkali metal salts of these compounds, and ammonium salts of these compounds are particularly preferred, and these compounds are used in a substantially boron compound-free single reagent type concentrated fixing solution at a concentration of 0.01 to 0.45 mol/L, and preferably from 0.03 to 0.3 mol/L. These compounds may be used singly or in combinations of two or more. Moreover, in a preferred mode of the present invention they are used in combination with an organic acid such as malic acid, tartaric acid, citric acid, succinic acid, oxalic acid, maleic acid, glycolic acid, benzoic acid, salicylic acid, Tiron, ascorbic acid, glutaric acid, or adipic acid, an amino acid such as aspartic acid, glycine, or cysteine, an aminopolycarboxylic acid such as ethylenediaminetetraacetic acid, diethylenetriaminepentaacetic acid, 1,3-propanediaminetetraacetic acid, nitrilotriacetic acid, or a saccharide.

As the hardening agent in the fixing solution of the present invention there are water-soluble aluminum and chromium salts. Water-soluble aluminum salts, for example, aluminum chloride, aluminum sulfate and potassium alum, are preferred compounds. The fixing temperature and time are preferably about 20° C. to about 50° C. and 5 seconds to 1 minute. The volume of fixing solution replenished is 300 ml/m² or less and particularly preferably 170 ml/m² or less.

In the processing method of the present invention, after the development and fixing processes, there is processing with washing water or a stabilizing solution, followed by drying. Processing with the washing water or the stabilizing solution can be at a replenishing volume of 3 liters or less (including zero, that is, washing in a reservoir) per m² of the light-sensitive material of the present invention. That is, not only can water be conserved in the processing but also piping for installation of an automatic processor is not required. As a method of reducing the volume of washing water replenished, a multistage countercurrent system (for example, two stages or three stages) has been long known. If this multistage countercurrent system is applied to the present invention, since the light-sensitive material after fixation is processed in a gradually cleaner direction, that is, sequentially contacted with processing solutions not contaminated with the fixing solution, more effective water washing can be carried out. When washing is carried out with a reduced amount of water, a washing tank provided with a squeegee roller or a crossover roller described in JP-A-63-18350, JP-A-62-287252, etc. is preferred. Furthermore, the addition of various kinds of oxidizing agents and the provision of filters for filtration may be combined to reduce environmental pollution which becomes a problem when washing with a small amount of water. In the above-mentioned water-conserving processing or piping-free processing, fungicidal means is preferably administered to the washing water or the stabilizing solution.

As the fungicidal means, an ultraviolet irradiation method described in JP-A-60-263939, a method using a magnetic field described in JP-A-60-263940, a method for purifying water using an ion exchange resin described in JP-A-61-131632, and methods using microbicidal agents described in JP-A-62-115154, JP-A-62-153952, JP-A-62-220951, and JP-A-62-209532 can be used. Moreover, microbicides, fungicides, surfactants, etc. described in L. F. West, “Water Quality Criteria”, Photo. Sci. & Eng., Vol. 9, No. 6 (1965), M. W. Reach, “Microbiological Growths in Motion-Picture Processing”, SMPTE Journal, Vol. 85 (1976), R. O. Deegan, “Photo Processing Wash Water Biocides”, J. Imaging Tech., Vol. 10, No. 6 (1984), JP-A-57-8542, JP-A-57-56143, JP-A-58-105145, JP-A-57-132146, JP-A-58-18631, JP-A-57-97530 and JP-A-57-157244 can be used in combination.

Moreover, isothiazolidine compounds described in R. T. Kreiman, J. Imaging Tech., 10 (6), page 242 (1984), and compounds described in Research Disclosure, Vol. 205, No. 20526 (No. 4, 1981) can be added as a microbicide to a washing bath or a stabilizing bath. In addition, compounds described in ‘Antibacterial and Antifungal Chemistry’, by Hiroshi Horiguchi, published by Sankyo Shuppan (1982), and the ‘Handbook of Antibacterial and Antifungal Technology’, edited by the Society for Antibacterial and Antifungal Agents, Japan, published by Hakuhodo (1986), may be contained in the washing water or the stabilizing solution.

When washing with a small volume of water in processing the light-sensitive material of the present invention, it is also preferable for the washing step to have a constitution such as that in JP-A-63-143548. Moreover, a part or all of the overflow generated from the washing bath or the stabilizing bath by the processing-dependent replenishment of the water, to which antifungal means has been administered, in the washing bath or the stabilizing bath in the method of the present invention can be utilized in a processing solution having a fixing function, which is used in a preceding processing step, as described in JP-A-60-235133. In the processing of the present invention, the developing time is 5 seconds to 3 minutes and preferably 8 seconds to 2 minutes, and the developing temperature is preferably 18° C. to 50° C. and more preferably 24° C. to 40° C.

The fixing temperature and time are preferably about 18° C. to about 50° C. for 5 seconds to 3 minutes, and more preferably 24° C. to 40° C. for 6 seconds to 2 minutes. Sufficient fixation can be obtained within this range, and sensitizing dyes can be leached out to an extent such that residual color is not generated. The washing (or stabilizing) temperature and time are preferably 5° C. to 50° C. for 6 seconds to 3 minutes, and more preferably 15° C. to 40° C. for 8 seconds to 2 minutes. The light-sensitive material that has been developed, fixed and washed (or stabilized) is dried by squeezing out the washing water, that is, by passing through squeegee rollers. Drying is carried out at about 40° C. to 100° C., and the drying time can be varied appropriately depending on the surrounding conditions but is generally from about 4 seconds to 3 minutes, and is particularly preferably 40° C. to 80° C. for about 5 seconds to 1 minute. When processing has a dry to dry time of 100 seconds or less, to prevent developer streaks specific to rapid processing, it is more preferable that rubber material rollers described in JP-A-63-151943 are applied to the rollers at the outlet of the developing tank, that the discharge flow rate for stirring the developing solution in the developing tank is set at 10 m/min or more as described in JP-A-63-151944 and, moreover that, as described in JP-A-63-264758, stirring is at least stronger during processing than during standby. Moreover, for rapid processing, to increase the fixing speed it is more preferable that the rollers in the fixing tank in particular have a constitution in which the rollers are opposed. The number of rollers can be reduced by using this opposed roller constitution and the size of the processing tank can be reduced. That is, it becomes feasible to make the automatic processor more compact.

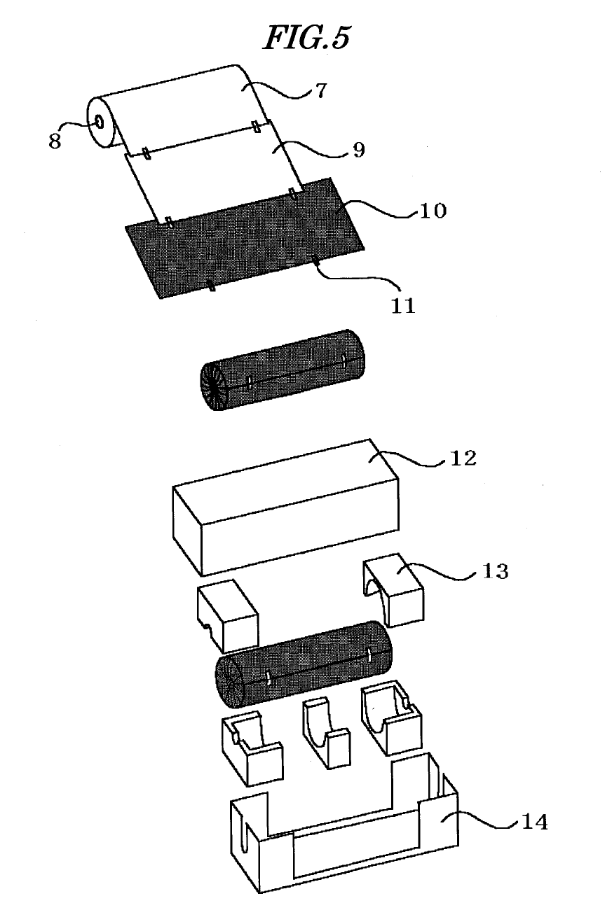

One embodiment of a preferred packaging configuration for the direct positive photographic light-sensitive material of the present invention is shown in FIG. 5. The direct positive photographic light-sensitive material 7 is wound around a core 8 with the light-sensitive layer on the inside, and is wrapped by a guide paper 9 and a black LDPE 10. The wrapped direct positive photographic light-sensitive material 7a is protected by foamed PE, etc. cushioning material 13 and housed in a cardboard box formed from a lid 12 and a body 14.

### EXAMPLES

The present invention is explained more specifically below by means of examples, but the modes for carrying out the present invention are not limited thereby.

### Example 1

Preparation of Emulsion

An aqueous solution of silver nitrate and an aqueous solution of potassium bromide were added simultaneously over 55 min at a constant speed by a double jet method to an aqueous solution of gelatin maintained at 41° C. in the presence of 5×10⁻⁵ mol of rhodium chloride per mol of silver to produce a monodisperse silver bromide emulsion with an average grain size of 0.20 μm. The emulsion was desalted by a flocculation method, after adjusting the pAg to 6.5, 3 mg of thiourea dioxide per mol of silver was added, and it was ripened at 65° C. until maximum performance was obtained, thereby generating fogging. This was emulsion 1.

As a comparative example, an aqueous solution of silver nitrate and an aqueous solution of potassium bromide were added simultaneously over 70 min at a constant speed by a double jet method to an aqueous solution of gelatin maintained at 60° C. in the presence of 2×10⁻⁵ mol of rhodium chloride per mol of silver to produce a monodisperse silver bromide emulsion with an average grain size of 1.1 μm. The emulsion was desalted by a flocculation method, after adjusting the pAg to 6.5, 1 mg of thiourea dioxide per mol of silver was added, and it was ripened at 65° C. until maximum performance was obtained, thereby generating fogging. This was emulsion 2.

Preparation of Coated Samples

After adding each of compounds A and B below to the above-mentioned emulsions 1 and 2 at 1×10⁻³ mol per mol of silver, 1,3-divinylsulfonyl-2-propanol was added as a hardening agent, and coating was carried out at a silver coat weight of 2.6 g/m². At this point, as a protective layer, an aqueous solution of gelatin containing a dispersion of ethyl acrylate was coated at the same time on a 100 μm polyethylene terephthalate film at a thickness that would give a thickness of 2 μm after drying. These coated samples were samples 1 and 2. Furthermore, sample 3 was prepared in the same way as for sample 1 except that coating was carried out to give a silver coat weight of 1.4 g/m². Moreover, sample 4 was prepared in the same way as for sample 1 except that a protective layer was not coated, and sample 5 was prepared in the same way as for sample 1 except that it was coated on 200 μm thick polyethylene terephthalate film.

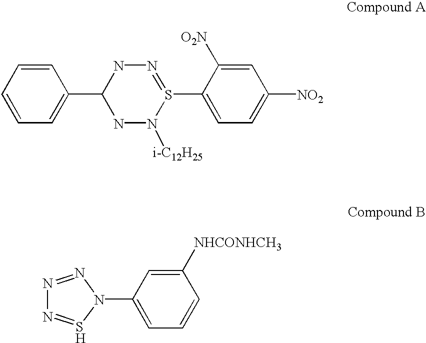

Exposure/Processing and Evaluation of Photographic Properties

After exposing these coated samples through a filter having a 100 μm interval silver image using a type P627 printer made by Dainippon Screen Mfg. Co., Ltd., developing, fixing, washing, and drying processes were carried out. For each coated sample, the exposure intensity was adjusted to the lowest value that gave the lowest density of dropouts, and the samples were then exposed at that exposure intensity. The developing and fixing solutions used were ND-1 and ND-F (both made by Fuji Photo Film Co., Ltd.), and the developing conditions were 30° C. for 60 seconds.

The processed samples were inspected using a 100× lupe for edge sharpness, edge fringing, and yellow stain of the black stripes so formed. The visual evaluation used a 5-stage scale, and a sample with excellent edge sharpness and little edge fringing and yellow stain was rated as 5. Unexposed samples were developed and the maximum density (Dₘₐₓ) was measured. Density measurement was carried out using a Macbeth densitometer. The results obtained are shown in Table 1.

TABLE 1

| | | Thickness | Total | Light- | | | | | |
|---|---|---|---|---|---|---|---|---|---|
| | | of light- | thickness | sensitive | | | | | |
| | Emulsion | sensitive | of light- | material | Silver | Density | | | |
| | average | material | sensitive | protective | coat | of un- | | | |
| | grain size | support | material | layer | weight | exposed | Yellow | Edge | |
| No. | (μm) | (μm) | (μm) | (μm) | (g/m²) | section | stain | sharpness | |
| 1 | 0.20 | 100 | 105 | 2 | 2.6 | 5.3 | 5 | 5 | Ex. |
| 2 | 1.10 | 100 | 105 | 2 | 2.6 | 2.3 | 4 | 3 | Comp. Ex. |
| 3 | 0.20 | 100 | 105 | 2 | 1.4 | 2.9 | 4 | 3 | Comp. Ex. |
| 4 | 0.20 | 100 | 103 | None | 2.6 | 5.4 | 5 | 5 | Ex. |
| 5 | 0.20 | 200 | 205 | 2 | 2.6 | 5.2 | 4 | 4 | Ex. |

As can be seen from Table 1, in accordance with the present invention, accurate black stripes highly suitable for use in lenticular lenses, and having little high density yellow stain could be easily formed.

### Example 2

Samples were prepared in the same way as for Example 1 except that silver chloride was used as the light-sensitive silver halide, and evaluation confirmed that the same excellent results as in Example 1 were obtained.

Effects of the Invention

In accordance with the present invention as explained above, a direct positive silver halide photographic light-sensitive material can be obtained for easily forming, on the light output side of a film substrate, accurate black stripes having fine pitched high resolution, and high density, and without incurring a reduction in contrast.

What is claimed is:

1. A direct positive silver halide photographic light-sensitive material used for forming a light-absorbing layer of a lenticular lens sheet comprising a film-form substrate and a plurality of light input lenses provided on a light input side of the substrate, the light absorbing layer (black stripe) being provided on a light output side of the substrate in a region other than a condensing region of each of the light input lenses, the silver halide photographic light-sensitive material comprising:
a support; and
at least one light-sensitive layer comprising light-sensitive silver halide grains with a grain size of 1 μm or less at a silver coat weight of 1.5 g/m² or more on one side of the support;
wherein on the side of the support opposite the light-sensitive layer there is no light absorbing layer, and
wherein by developing after exposing, from the side opposite the light-sensitive layer via the light input lenses, the light absorbing layer is formed based on a silver image.

2. The direct positive silver halide photographic light-sensitive material according to claim 1, further comprising a protective layer on the side of the light-sensitive layer opposite the support.

3. The direct positive silver halide photographic light-sensitive material according to claim 1, wherein the total thickness of the silver halide photographic light-sensitive material is at most 200 μm.

4. The direct positive silver halide photographic light-sensitive material according to claim 1, wherein the halogen composition of the light-sensitive silver halide grains is such that the silver chloride content is 0 to 10 mol % or 80 to 100 mol %.

5. The direct positive silver halide photographic light-sensitive material according to claim 1, further comprising a high transmittance translucent clear layer that is provided on the surface of the light output side of the direct positive silver halide photographic light-sensitive material after exposure and developing processes.

6. The direct positive silver halide photographic light-sensitive material according to claim 1, further comprising a light diffusing layer.

7. The direct positive silver halide photographic light-sensitive material according to claim 1, further comprising a surface treatment layer.

8. The direct positive silver halide photographic light-sensitive material according to claim 2, wherein the protective layer comprises a hydrophilic colloid.

9. The direct positive silver halide photographic light-sensitive material according to claim 1, further comprising a light insensitive layer between the light-sensitive layer and the support.

10. The direct positive silver halide photographic light-sensitive material according to claim 1, further comprising an auxiliary layer.

11. The direct positive silver halide photographic light-sensitive material according to claim 1, wherein the total thickness of the photographic light-sensitive material is at least 25 μm and at most 200 μm.

12. The direct positive silver halide photographic light-sensitive material according to claim 1, wherein the light-sensitive silver halide grains comprise silver bromide, silver chlorobromide, or silver chloride.

13. The direct positive silver halide photographic light-sensitive material according to claim 1, wherein the halogen composition of the light-sensitive silver halide grains is silver iodochlorobromide such that the silver chloride content is 0 to 80%, and the silver iodide content is 0 to 10%.

14. The direct positive silver halide photographic light-sensitive material according to claim 1, wherein the grain size of the light-sensitive silver halide grains is 0.05 to 1.0 μm.

15. The direct positive silver halide photographic light-sensitive material according to claim 1, wherein the grain size distribution of the light-sensitive silver halide grains is such that 90% of the total number of grains is within the range of ±40% of the average grain size.

16. The direct positive silver halide photographic light-sensitive material according to claim 1, wherein the amount of a silver halide emulsion coated is preferably at least 1.5 g/m² and at most 10 g/m².

17. The direct positive silver halide photographic light-sensitive material according to claim 1, wherein the support comprises a polyethylene terephthalate film.

18. The direct positive silver halide photographic light-sensitive material according to claim 1, wherein it is wound on a spool with the light-sensitive layer on the inside, and is wrapped with a guide paper and a black LDPE.

19. The direct positive silver halide photographic light-sensitive material according to claim 18, wherein it is protected by a cushioning material such as foamed PE, and in addition is housed in cardboard.
